(19) United States
(12) Patent Application Publication
(10) Pub. No.: US 2007/0008888 A1
(43) Pub. Date: Jan. 11, 2007

(54) Direct lookup tables and extensions thereto for packet classification

(76) Inventors: Shuchi Chawla, Tigard, OR (US); Teresa Buckley, Boulder, CO (US); Vijay Sarathi Kesavan, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/170,004

(22) Filed: Jun. 28, 2005

(51) Int. Cl. H04L 12/26

(52) U.S. Cl. 370/230

(57) ABSTRACT

Packets may be classified into flows using direct lookup tables. The classification includes receiving a packet including a packet field having a corresponding field value. A direct lookup table (“DLT”) is indexed into at a DLT offset matching the field value to determine whether one or more of classification rules for classifying the packet into one or more flows are indexed at the DLT offset matching the field value. The DLT includes at least a portion of the classification rules indexed at any of multiple DLT offsets within the DLT according to at least one bit matching mask. In some cases, the packet field may be segmented into packet sub-fields having corresponding sub-field values and multiple strided DLTs are indexed into at DLT offsets matching the corresponding sub-field values to determine the matching classification rules for each of the sub-field values.

### TECHNICAL FIELD

This disclosure relates generally to packet based networks, and in particular but not exclusively, relates to classification of packets into flows using direct lookup tables.

### BACKGROUND INFORMATION

Modern packet switching networks are used to carry a variety of different types of information for a wide variety of users and applications. As the use of packet based networks and the diversity of applications to be supported is increasing, support for advanced networking services such as Service Level Agreement (“SLA”) monitoring, traffic engineering, security, billing and the like, to name a few, is becoming a requirement. For example, each user of a network may negotiate an SLA with the network provider detailing the level of service that is expected while the SLA is in effect. The SLA may specify bandwidth availability, response times, Quality of Service (“QoS”), and the like.

One technique for implementing these advanced network services is to classify packets transported within the network into flows and assign actions to be taken on the packets based on the flow assignment. For example, all packets received at a particular network node that require a specified QoS and share a common destination may be assigned to the same flow. Based on the flow assignment, the network may ensure all packets of this flow receive the appropriate priority and reserve the necessary bandwidth along the path to the destination. The criteria for classification into flows may be diverse; it may include information from the header of a packet, some part of the packet payload or other information such as the ingress or egress interface associated with the packet. This criteria for classification is specified in the form of classification rules. Any packet matching the criteria specified in a classification rule will be classified into the same flow. A flow may specify a source-destination pair, a TCP/IP tuple, or any other packet characteristic.

In general there is an inverse relationship between memory consumption for data structures used by the classifier and classification time. Since packet classification is normally executed in the data path, the impact on the data rate due to packet classification should be minimized. Additionally, the amount of memory available in the data plane tends to be limited. Therefore, a packet classification technique should attempt to strike a proper balance between memory consumption and classification time, while satisfying the data rate demands of the network.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a block diagram illustrating a network implementing packet classification, in accordance with an embodiment of the invention.

FIG. 2A is a block diagram illustrating a packet including packet fields that may be parsed for packet classification, in accordance with an embodiment of the invention.

FIG. 2B is a table illustrating the definition of a classification rule and the one-to-one correspondence between a classification rule and a flow, in accordance with an embodiment of the invention.

FIG. 2C is a block diagram illustrating an example classification pattern used for packet classification, in accordance with an embodiment of the invention.

FIG. 3 is a functional block diagram illustrating a network node for implementing packet classification, in accordance with an embodiment of the invention.

FIG. 4 is a block diagram illustrating how field values are used to index into a direct lookup table storing classification rules, in accordance with an embodiment of the invention.

FIG. 5 illustrates examples of five different bit matching masks applied to specified field values to derive direct lookup table offsets for indexing classification rules thereto within a direct lookup table, in accordance with an embodiment of the invention.

FIG. 6 is a table illustrating a set of matching classification rules indexed to direct lookup table offsets by application of five different bit matching masks to specified field values, in accordance with an embodiment of the invention.

FIG. 7A illustrates a first portion of example pseudo-code for adding classification rules to a direct lookup table using bit matching masks, in accordance with an embodiment of the invention.

FIG. 7B illustrates a second portion of example pseudo-code for adding classification rules to a direct lookup table using bit matching masks, in accordance with an embodiment of the invention.

FIG. 8 is a block diagram illustrating strided direct lookup tables used for packet classification, in accordance with an embodiment of the invention.

FIG. 9 is a flow chart illustrating a process for packet classification using direct lookup tables that implement bit matching masks, in accordance with an embodiment of the invention.

FIG. 10 is a flow chart illustrating a process for modifying direct lookup tables that implement bit matching masks, in accordance with an embodiment of the invention.

FIG. 11 is a block diagram illustrating a demonstrative processing device for implementing embodiments of the invention.

### DETAILED DESCRIPTION

Embodiments of a system and method for packet classification using direct lookup tables are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification may or may not refer to the same embodiment. Furthermore, the particular features, structures, or characteristics may be combined in any suitable manner in one or more embodiments.

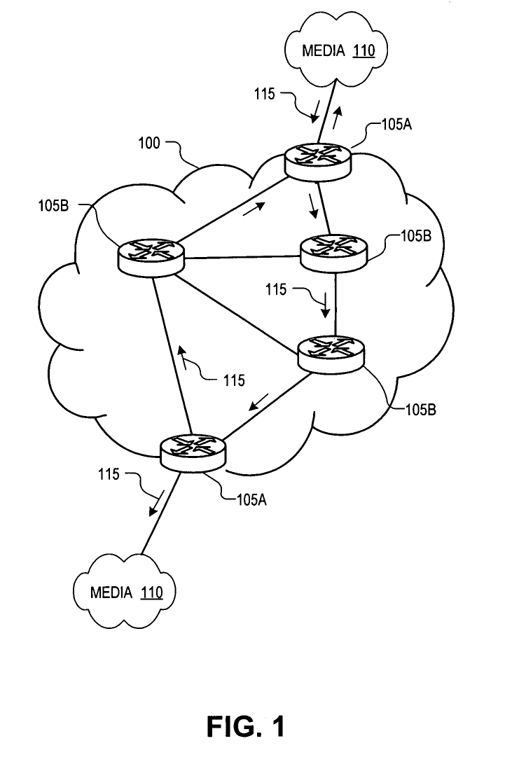

FIG. 1 is a block diagram illustrating a network 100 implementing packet classification into flows, in accordance with an embodiment of the invention. The illustrated embodiment of network 100 includes network nodes 105A and 105B (collectively 105) coupled together to transport packets across network 100. Network nodes 105A are referred to as edge nodes and are coupled to external media 110 (e.g., external networks, computers, etc.), while network nodes 105B are internal nodes and may be coupled to other internal nodes 105B and/or edge nodes 105A. As packets 115 (only a portion of which are labeled) arrive at network nodes 105, packets 115 are classified into flows. Classifying packets 115 into flows can aid hardware and/or software of network nodes 105 to implement a number of advanced network services including: service level agreement (“SLA”) monitoring, traffic engineering, security, billing tracking, quality of service (“QoS”), generating and maintaining statistical data, and the like.

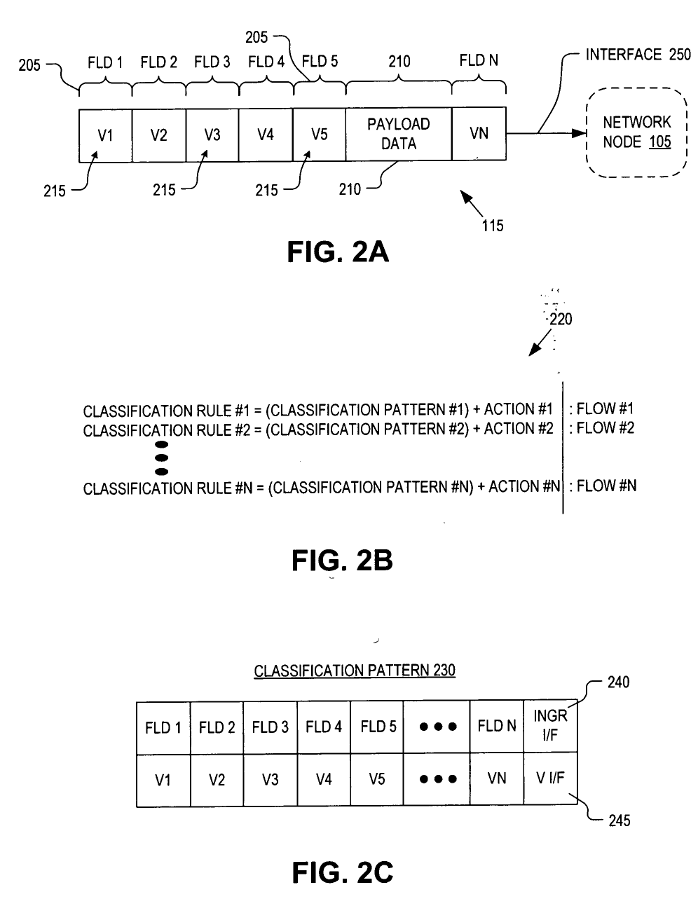

FIG. 2A is a block diagram illustrating one of packets 115 having packet fields 205 that may be parsed for packet classification, in accordance with an embodiment of the invention. As illustrated, packet 115 includes a number of packet fields 205 (FLD 1-N) and a payload field 210; each of which begins at a specified offset within packet 115 and has a defined length. Each packet field 205 contains a corresponding field value 215 (V1-VN). Field values 215 may represent header or footer information, such as protocol information, address information, error checking information, and the like. Similarly, payload field 210 defines that portion of packet 115 containing payload data. Although payload field 210 is labeled as distinct from packet fields 205, the term packet field is intended to be a generic term that includes the payload field, which is simply a special type of packet field.

When a packet 115 is received at one of network nodes 105, packet 115 is parsed to extract one or more field values 215 from packet fields 205. The extracted field values 215 are then used to search a rule database to determine the set of classification rules that packet 115 matches, and hence the associated set of resulting flows. FIG. 2B illustrates a classification rule definition table 220 depicting the definition of a classification rule and the one-to-one correspondence between a classification rule and a flow. A classification rule is the combination of a classification pattern plus an action. In general, each classification rule has a one-to-one correspondence with a flow. Accordingly, if one of packets 115 is found to match one or more classification rules, then the particular packet 115 will be assigned to the corresponding one or more flows.

FIG. 2C is a block diagram illustrating example classification pattern 230, in accordance with an embodiment of the invention. A classification pattern includes a combination of packet fields 205 plus specified field values 215 (or specified field values having bit matching masks applied thereto, as discussed below). A classification pattern may also include other non-packet criteria with associated values, such as an ingress interface field 240 having an associated value 245. Ingress interface field 240 identifies on which ingress interface 250 packet 115 was received within one of network nodes 105. Other non-packet criteria may include an egress interface field or the like. The term “field value” is defined broadly herein to include these other non-packet criteria.

Returning to FIG. 2B, an action defines an action to be taken on packets 115 classified into a particular flow. For example, an action may include updating statistical information relating to the flow, assigning the packet 115 to a high priority queue, or the like. It should further be appreciated that the action associated with different flows may be different or indeed the same or partially the same. A flow is a logical construct, typically maintained within software running on network nodes 105, which is used to monitor those packets 115 having similar defined characteristics (i.e., packets that match the same classification pattern). The action associated with a rule is performed on all packets 115 that are classified into the same flow based on matching the classification pattern specified by the corresponding classification rule.

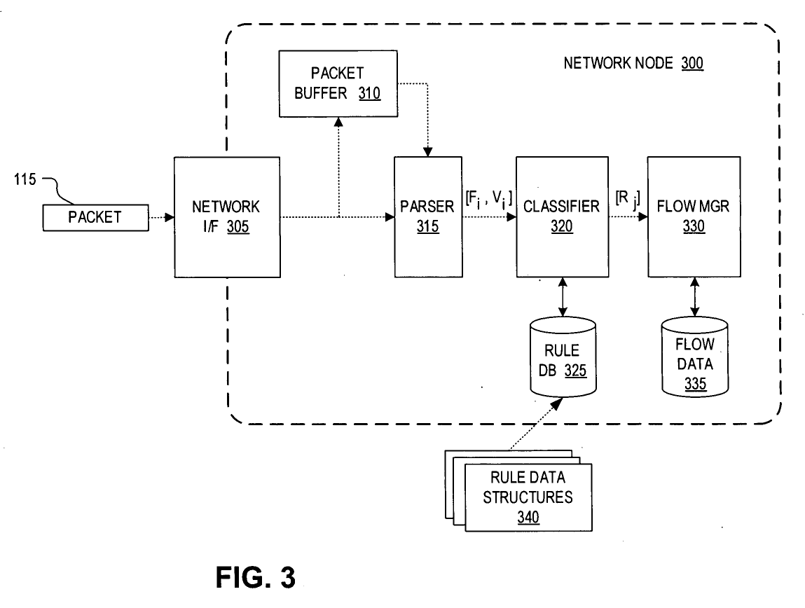

FIG. 3 is a functional block diagram illustrating functional components of a network node 300 for implementing packet classification on packets 115, in accordance with an embodiment of the invention. Network node 300 is one possible embodiment of network nodes 105. Network node 300 may represent any network processing entity including, a switch, a router, a computer, a network processing unit, and the like. The illustrated embodiment of network node 300 includes a network interface 305, a packet buffer 310, a parser 315, a classifier 320, a rule database 325, a flow manager 330, and flow data 335. It should be appreciated that only those functional components particularly relevant to the task of packet classification have been illustrated in FIG. 3, while other components have been excluded for the sake of clarity and so as not to obscure the invention. The functional blocks illustrated in FIG. 3 may be implemented in software and executed by micro-processors, implemented entirely in hardware, or otherwise. Furthermore, it should be appreciated that each illustrated functional block may be implemented by a single processing entity, multiple processing entities, or multiple functional blocks may be implemented by a single processing entity.

When a packet 115 is received at network node 300 on network interface 305, it may be temporarily stored within a packet buffer 310 and then provided to parser 315. Alternatively, the received packet 115 may be provided directly to parser 315 without need of packet buffer 310. Parser 315 parses packet 115 to extract field values 215 from packet fields 205 and provides field values 215 (illustrated as field values Vᵢ) to classifier 320. Classifier 320 uses field values 215 (including the non-packet packet criteria such as ingress interface value 245) as indexes into rule data structures 340 stored within rule database 325 to find rule “hits” and thereby classify packet 115 into one or more flows. Classifier 320 provides flow manager 330 with matching rules Rⱼ, which flow manager 330 then uses to update a flow data 335.

It should be appreciated that FIG. 3 illustrates those portions of network node 300 relevant to the task of packet classification from a functional perspective. Although parser 315 and classifier 320 are illustrated as distinct entities, they may in fact simply represent different functionality of a single hardware or software architectural entity. Furthermore, the tasks of parsing and classifying need not be distinct; rather, they may occur in parallel, in a circular fashion, or in unison. For example, parser 315 and classifier 320 may act together to perform a field examination of the contents of each packet field 215. In one embodiment, parser 315 parses each packet field 205 “just-in-time” prior to the particular packet field 205 being classified by classifier 320.

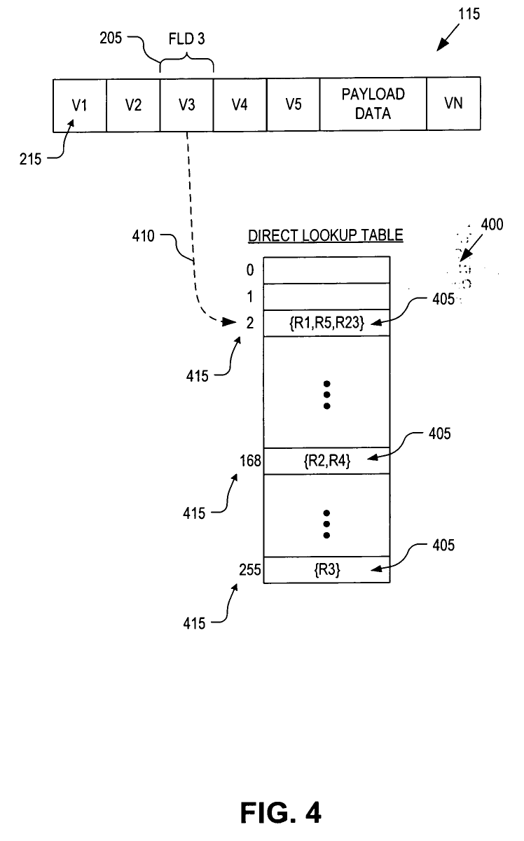

FIG. 4 is a block diagram illustrating how field values 215 are used to index into a direct lookup table (“DLT”) 400 storing classification rules 405, in accordance with an embodiment of the invention. DLT 400 represents one embodiment of one of rule data structures 340. DLT 400 may be accessed by classifier 320 during operation of network node 300 to efficiently classify packets 115 into flows.

FIG. 4 illustrates an 8-bit wide (e.g., 2⁸=256 offsets) DLT; however, embodiments of the invention are equally applicable to DLTs of greater or lesser size. As illustrated by line 410, field values 215 are used to index into DLT 400. In other words, a DLT offset 415 having an equivalent value to the corresponding field value 215 holds the matching classification rules 405 corresponding to the particular packet field 205. Accordingly, DLT offsets 415 have the same bit width as the corresponding packet field 205. The set of classification rules 405 indexed to a particular DLT offset 415 may be stored as an aggregated bit vector (“ABV”) or other convenient form. In the illustrated example, packet field FLD 3 would contain a field value equal to binary “00000010”, which would be used to index into DLT offset 2. DLT offset 2 is illustrated as storing matching classification rules R1, R5, and R23. One or more different DLTs 400 may be maintained within rule database 325 for each packet field 205 used for classification. Once matching classification rules 405 have been determined for each packet field 205 used for classification, the matching classification rules 405 for each packet field 205 may be intersected to determine a set of resultant matching classification rules, which are ultimately used to classify each packet 115 into a flow. Furthermore, intersection of resultant matching classification rules may be executed as each set of matching classification rules is determined for a packet field 205, thereby enabling early classification termination if a null set is found.

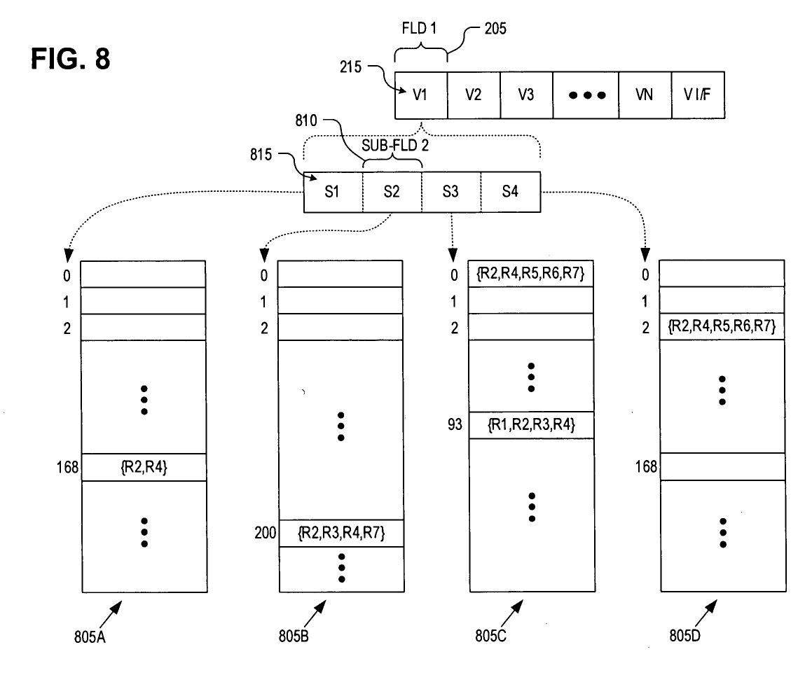

DLT 400 is a type of rule data structure 340 that is very fast and efficient for looking up matching classification rules 405. It should be appreciated that classification time using DLT 400 is independent of the number of classification rules 405. Irrespective of the average number of classification rules 405 indexed to each DLT offset 415 or of the number of DLT offsets 415 within DLT 400 (i.e., 2^{N} offsets) only a single indexing operation into DLT 400 yields all matching classification rules 405 for the corresponding packet field 205. However, as the length of DLT 400 increases (e.g., 2^{N} offsets), the memory consumed by DLT 400 exponential increases. A technique to selectively balance memory consumption of DLT 400 against lookup time using strided DLTs is described below in connection with FIG. 8.

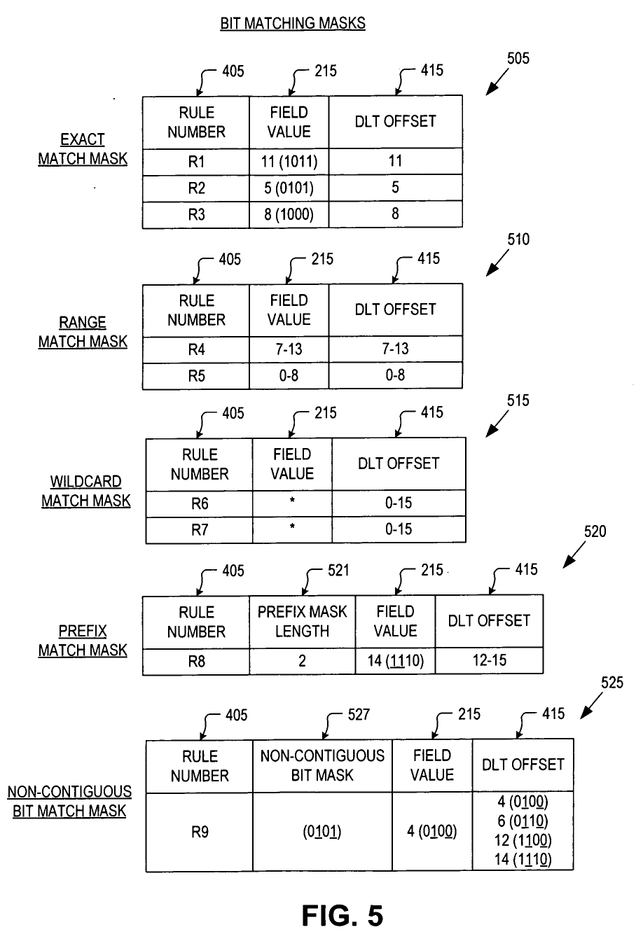

FIG. 5 illustrates examples of five different bit matching masks that may be used in connection with DLT 400 to index classification rules 405 to DLT offsets 415 for matching to field values 215, in accordance with an embodiment of the invention.

Table 505 illustrates an example exact match mask. An exact match mask indexes one of classification rules 405 to a single DLT offset 415 and therefore a corresponding single field value 215. As illustrated by table 505, a classification rule R1 is indexed to DLT offset 415 having a value “11” (or “1011” in binary), which would match a field value 205 equal to “11” (or “1011” in binary). Table 505 further illustrates classification rules R2 and R3 indexed to DLT offsets equal to “5” and “8”, respectively.

Table 510 illustrates an example range match mask. A range match mask indexes one of classification rules 405 to a range of DLT offsets 415, which would match a range of field values 215 for a single packet field 205. As illustrated by table 510, a classification rule R4 is indexed to all DLT offsets 415 having values ranging from “7” to “13” (or from “0111” to “1101” in binary), inclusive, which would match field values 205 ranging from “7” to “13”. Table 510 further illustrates classification rule R5 indexed to DLT offsets 415 ranging from “0” to “8”.

Table 515 illustrates an example wildcard match mask. A wildcard match mask indexes one of classification rules 405 to all DLT offsets 415 within DLT 400, such that each DLT offset 415 matches one of all possible field values 215 of a single packet field 205. As illustrated by table 515, a classification rule R6 is indexed to all DLT offsets 415 (e.g., 0-15 for a 4-bit DLT such as DLT 400), which would match all possible field values 205. Table 515 further illustrates classification rule R7 indexed to all DLT offsets 415.

Table 520 illustrates an example prefix match mask. A prefix match mask indexes one of classification rules 405 to each DLT offset 415 having a specified number of most significant bits (“MSBs”), referred to as a prefix mask length 521, matching a corresponding number of MSBs of one of field values 205. As illustrated by table 520, a classification rule R8 has a prefix mask length equal to 2-bits for matching a field value 215 equal to “14” (or “1110” in binary). Therefore, classification rule R8 is indexed to all DLT offsets 415 having the first two MSBs equal to “11” in binary, which corresponds to decimal values ranging from “12” to “15”, inclusive.

Table 525 illustrates an example non-contiguous bit match mask. A non-contiguous bit match mask indexes one of classification rules 405 to each DLT offset 415 having bit values at specified non-contiguous bit positions matching corresponding bit values at corresponding non-contiguous bit positions of one of field values 215. A non-contiguous bit match mask specifies the bit positions using a non-contiguous bit mask 527 and specifies the values to match at the bit position specified by non-contiguous bit mask 527 with one of field values 215. As illustrated by table 525, a classification rule R9 has a non-contiguous bit mask 527 equal to “0101” indicating that the bit positions represented with a “1” are to be matched. Table 525 further illustrates a field value 215 equal to “4” (or “0100” in binary) for matching against, indicating that the second and fourth MSB positions for matching against should equal “1” and “0”, respectively. Therefore, classification rule R9 is indexed to DLT offsets 415 having decimal values equal to “4”, “6”, “12”, and “14”, as illustrated.

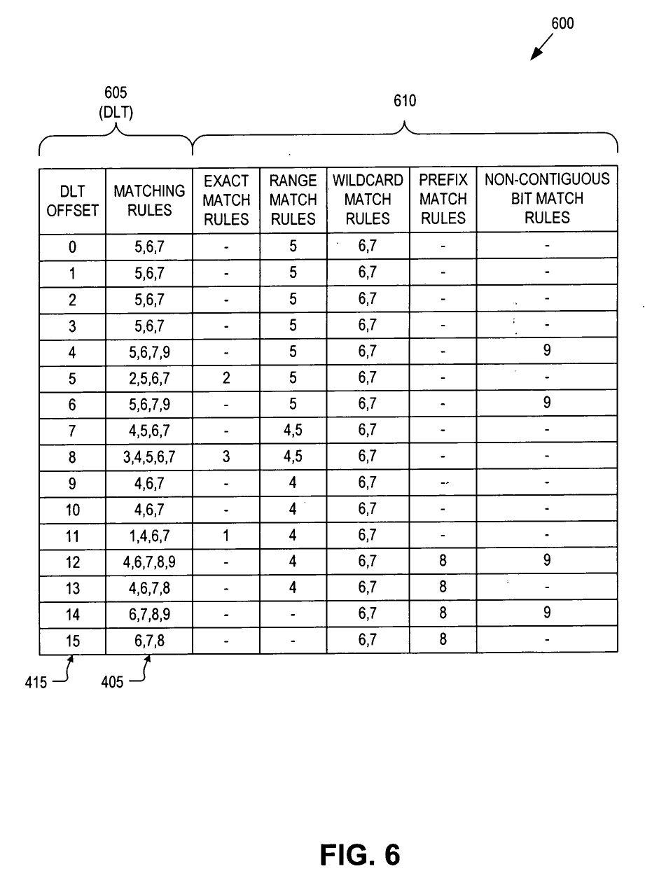

FIG. 6 illustrates a table 600 illustrating how a single DLT could index classification rules 415 using all five example bit matching masks illustrated in FIG. 4, in accordance with an embodiment of the invention. The information in columns 605 would be indexed to each other and represent a DLT, while the information provided in columns 610 is merely presented for explanatory purposes. It should be appreciated that table 600 merely continues the examples illustrated in FIG. 5. A DLT, such as DLT 400, may include any number of classification rules 405 indexed to any number of DLT offsets 415, using one or more of the bit matching masks described above (e.g., an exact match mask, a range match mask, a wildcard match mask, a prefix match mask, a non-contiguous bit match mask, etc.) other bit matching masks not described, all within a single DLT.

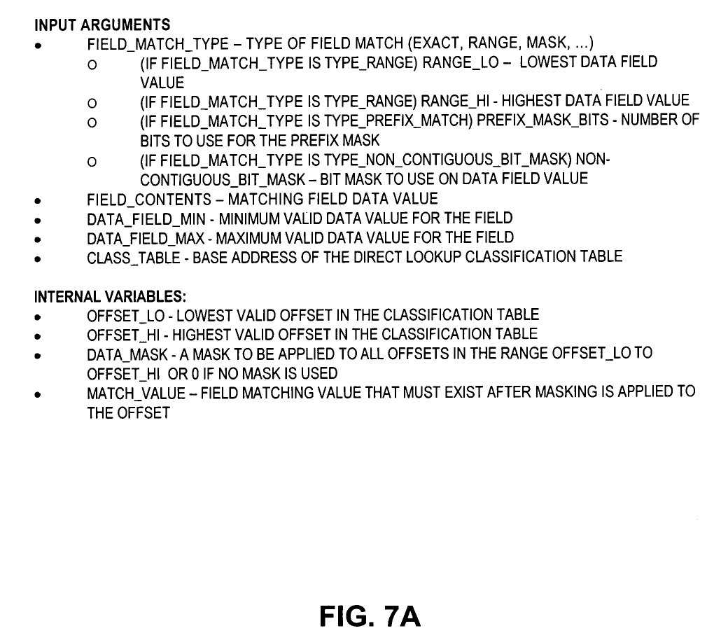

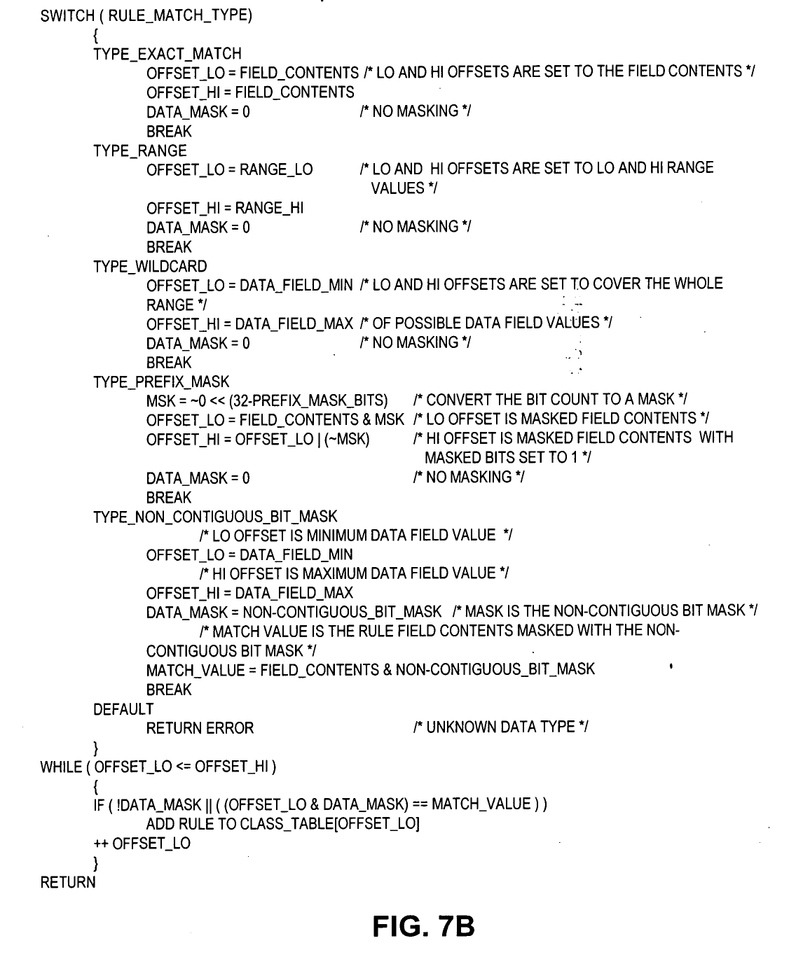

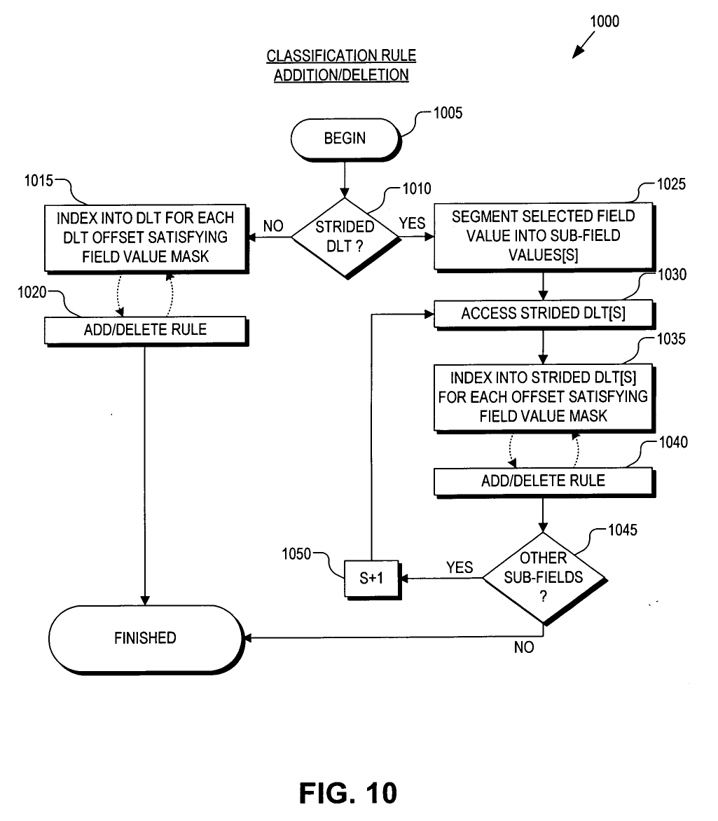

FIGS. 7A and 7B illustrate example pseudo-code for adding classification rules 415 to DLT 400 using the bit matching masks described above, in accordance with an embodiment of the invention. The pseudo-code is self-explanatory and is merely provided as an example. Other techniques or approaches than the technique illustrated by the provided pseudo-code may be implemented. The pseudo-code is further explained with reference to FIG. 10 below.

FIG. 8 is a block diagram illustrating strided DLTs 805A, 805B, 805C, and 805D (collectively 805) used for packet classification, in accordance with an embodiment of the invention. Strided DLTs 805 may be implemented by decomposing packet fields 205 into packet sub-fields 810 each having corresponding sub-field values 815 (S1-SN).

FIG. 8 illustrates an example where field value FLD 1 is decomposed into four packet sub-fields 810 having sub-fields values S1, S2, S3, and S4. As an example, packet field FLD 1 may be a 32-bit Internet protocol (“IP”) address segmented into four 8-bit packet sub-fields 810. An IP address (e.g., IPv4, IPv6, etc.) is considered herein for the purposes of illustration, and the techniques described are by no means limited for use with the IP address of a packet. In this example, DLT 400 corresponding to packet field FLD 1 is segmented into four strided DLTs 805 with each strided DLT 805 having a stride of 8-bits. The 32-bit IP address represented by packet field FLD 1, and the other packet fields for that matter, may be segmented in a variety of manners, such as eight 4-bit packet sub-fields 810, three 10-bit packet sub-fields 810 and one 2-bit packet sub-field 810, or otherwise. Some or all packet fields 205 of a single packet 115 may be segmented with each packet field 205 segmented having the same or different strides.

Strided DLTs 805 are an extension of DLT 400. A single DLT is feasible when the size of the packet field 205 being represented by the DLT is small enough so as not to result in excessive use of memory. For example, a packet field 205 of width 8-bits may be represented with by a DLT having 28 DLT offsets. However, a packet field 205 of width 16-bits or 32-bits requires a DLT having 216 or 232 DLT offsets, which can be very expensive in terms of memory usage and consumption. Segmenting a 32-bit packet field 205 into four 8-bit packet sub-fields 810 results in a substantial savings in terms of memory consumption (i.e., 4.2⁸=1024 DLT offsets as opposed to 2³² DLT offsets) with an increase in lookup time based on the number of strides, which in comparison to conventional approaches is negligible. The cost associated with finding a set of resultant matching classification rules using strided DLTs 805 is divided into two parts: the cost of finding the matching classification rules per strided DLT 805 and the cost of intersecting the sets of matching classification rules to determine the resultant matching classification rule for a packet field 205. Since strided DLTs 805 are still a form of DLT 400, multiple bit matching masks may still be supported, as described above.

Strided DLTs 805 enable a network administrator or developer to selectively tradeoff classification time for memory consumption by increasing the stride sizes of the individual strided DLTs 805 to decrease the number strided DLTs 805. Conversely, if memory happens to be the scarce commodity, then the stride sizes can be selectively decreased resulting in more individual strided DLTs 805, but lower overall memory consumption.

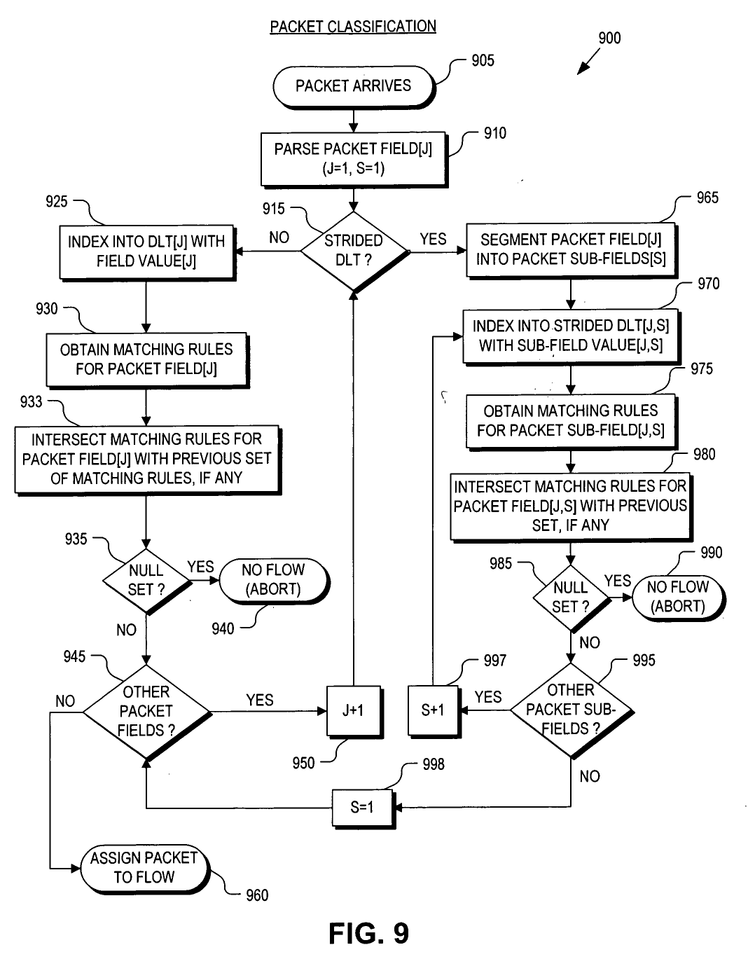

FIG. 9 is a flow chart illustrating a process 900 for packet classification using DLTs (e.g., both DLT 400 or strided DLTs 805) that implement bit matching masks, in accordance with an embodiment of the invention. The processes explained below are described in terms of computer software and hardware. The techniques described may constitute machine-executable instructions embodied within a machine (e.g., computer) readable medium, that when executed by a machine will cause the machine to perform the operations described. Additionally, the processes may be embodied within hardware, such as an application specific integrated circuit (“ASIC”) or the like. The order in which some or all of the process blocks appear in each process should not be deemed limiting. Rather, one of ordinary skill in the art having the benefit of the present disclosure will understand that some of the process blocks may be executed in a variety of orders not illustrated.

In a process block 905, one of packets 115 arrives at network node 300. Upon arrival, one or more packet fields 205 of the received packet 115 is parsed (process block 910). Packets 115 may be parsed into packet fields 205 or packet sub-fields 810 all at once and the parsed portions worked upon by classifier 320 to classify the received packet 115 into a flow. Alternatively, only a portion of the received packet 115 may be parsed at time (e.g., just-in-time parsing), and each portion classified one-by-one or multiple portions classified in parallel one-by-one. Process 900 illustrates a technique to classify packets 115 having “j” number of packet fields 205 and/or “s” number of packet sub-fields 810 per packet field 205. It should be appreciated that the number of “s” packet sub-fields 810 may vary for each packet field 205.

If the current packet field[j] being classified is small enough not to be segmented or is not segmented for other reasons (decision block 915), then process 900 continues to a process block 920 and packet classification proceeds with reference to FIG. 4 and DLT 400. FIG. 4 illustrates only a single DLT 400 for obtaining matching classification rules 405 corresponding to a single one of packet fields 205; however, process 900 details a technique for classifying packets 115 into flows based on “j” number of packet fields of a single packet 115. Therefore, a different DLT 400 or other rule data structure 340 may be maintained for each packet field[j].

In a process block 925, the current field value[j] corresponding to the current packet field[j] is used to index into a DLT[j]. In a process block 930, the matching classification rules 405 indexed to the DLT offset matching the field value[j] are determined. In a process block 933 the matching classification rules are intersected with the previous set of matching classification rules, if any (e.g., j>1) to determine a resultant set of matching classification. If the current matching classification rules 405 obtained in process block 930 are determined to be a NULL set or if the resultant set after intersection is a NULL set, then no set of resultant matching classification rules currently exists (decision block 935). Therefore, the received packet 115 does not match any currently registered flows and is not classified into a flow (process block 940).

However, if the set of matching/resultant classification rules 405 is not a NULL set and other packet fields 205 have yet to be classified (decision block 945), then j is increased by 1 (process block 950) indicating that the next packet field[j+1] is to be classified and process 900 returns to decision block 915. If the next packet field[j+1] is also not to be segmented into strides, then process 900 continues to process block 920 and loops around as described above. Once all packet fields[j] have been classified (decision block 945), and a final set of resultant matching classification rules determined, the received packet 115 is assign to a flow (process block 960).

Returning to decision block 915, if the current packet field[j] 205 is to be segmented and classified based on strided DLTs (e.g., strided DLTs 805), then process 900 continues to a process block 965. In process block 965, the current packet field[j] is segmented into “s” number of packet sub-fields 810. In a process block 970, the current sub-field value[j,s] corresponding to the current packet sub-field[j,s] is used to index into a strided DLT[j,s]. In a process block 975, the matching classification rules 405 indexed to the DLT offset matching the sub-field value[j,s] are determined. In a process block 980 the matching classification rules are intersected with the previous set of matching classification rules, if any (e.g., s>1), to determine a set of resultant matching classification rules. If the current matching classification rules 405 obtained in process block 975 are determined to be a NULL set or if the set of resultant matching classification rules is determined to be NULL after intersecting, then no set of resultant matching classification rules exists (decision block 985), therefore the received packet 115 does not match any currently registered flows and is not classified into a flow (process block 990).

If other packet sub-fields 810 have yet to be classified (decision block 995), then s is increased by 1 (process block 997) indicating that the next packet sub-field[j,s+1] is to be classified and process 900 returns to process block 970 and continues therefrom as described above. If all packet sub-fields 810 for the current packet field[j] have been classified (decision block 995), then the set of resultant matching classification rules 405 for each of the packet sub-fields 810 of the current packet field[j] have been determined and process 900 continues to a process block 998.

In process block 998, ‘s’ is reset to ‘1’ (process block 998) and process 900 continues to decision block 945. If other packet fields 205 have yet to be classified (decision block 945), then j is increased by 1 (process block 950) and process 900 continues as described above. Otherwise, all packet fields[j] and all packet sub-fields[s] have been classified, and the matching classification rules 405 corresponding to each packet field[j] have been intersected to determine the final set of resultant matching classification rules for assigning the received packet 115 into a flow (process block 960).

FIG. 10 is a flow chart illustrating a process 1000 for modifying DLTs that implement bit matching masks, in accordance with an embodiment of the invention. Process 1000 is applicable to both DLT 400 or strided DLTs 805. Process 1000 is repeated for each packet field 205 of a packet 115 to be used for classification.

Process 1000 begins at a block 1005. If a classification rule is to be added or deleted to/from a non-strided DLT (e.g., DLT 400) (decision block 1010), then process 1000 continues to a process block 1015. In process block 1015, the DLT is indexed into each DLT offset, which satisfies a selected field value when any of the bit matching masks (e.g., exact match mask, range match mask, wildcard match mask, prefix match mask, non-contiguous bit match mask, etc.) are applied thereto. At each DLT offset satisfying the selected field value with the applied bit matching mask, the classification rule is either added or deleted, as the case may be. Accordingly, process blocks 1015 and 1020 may be iterative or cyclical steps which are repeated until the selected classification rule has been added or deleted to/from all matching DLT offsets.

Returning to decision block 1010, if the classification rule is to be added or deleted to/from strided DLTs, then process 1000 continues to a process block 1025. In process 1025, the selected field value is segmented into “s” number of sub-field values. The first strided DLT[s] is accessed corresponding to the first sub-field value[s] (process block 1030). At each DLT offset within the strided DLT[s] matching the sub-field value[s] with the selected bit matching mask applied thereto, the classification rule is either added or deleted according to the desired modification operation (process block 1040). It should be appreciated that process blocks 1035 and 1040 may be iterative or cyclical steps which are repeated until the selected classification rule has been added or deleted to/from all matching DLT offsets within the strided DLT[s]. It should also be appreciated that the time consumed to add a classification rule to DLT 400 or strided DLTs 805 is independent of the total number of classification rules currently registered within DLT 400 or strided DLTs 805. In other known rule data structures this is not the case. For example, tree rule data structures require rebalancing after modification which is time dependent based on the number of classification rules registered therein.

If other packet sub-fields[s] have yet to be accessed (decision block 1045), then the value of “s” is incremented (process block 1050), and process 1000 loops back to process block 1030 and continues therefrom as described above. Once all packet sub-fields[s] of a given packet field 205 have been used to access all strided DLT[s], then the selected classification rule has been added or deleted. It should be appreciated that process 1000 illustrates the procedure to update a single DLT or multiple strided DLTs corresponding to a single packet field 205 of a packet 115. Process 1000 may have to be repeated for each packet field 205 used for classifying packets 115 into a flow. Adding or removing a classification rule from DLT 400 or strided DLTs 805 can be, in the worst case scenario of a wildcard match mask, considerably more time consuming than accessing DLT 400 or strided DLTs 805 for the purpose of packet classification. However, compared to packet classification, classification rule modification is executed relatively infrequently and therefore a reasonable tradeoff to achieve relatively fast classification time, with reasonable memory consumption.

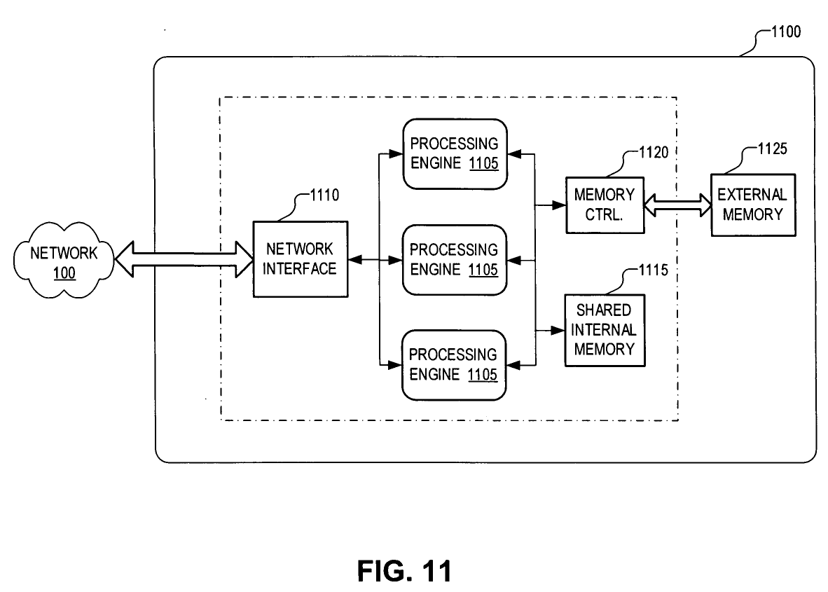

FIG. 11 illustrates an example processing device 1100 for implementing packet classification using DLTs and/or strided DLTs in connection with various bit matching masks as described, in accordance with the teachings of the invention. Processing device 1100 is one possible embodiment of network nodes 105. The illustrated embodiment of processing device 1100 includes processing engines 1105, a network interface 1110, shared internal memory 1115, a memory controller 1120, and external memory 1125.

The elements of processing device 1100 are interconnected as follows. Processing engines 1105 are coupled to network interface 1110 to receive and transmit packets 115 from/to network 100. Processing engines 1105 are further coupled to access external memory 1125 via memory controller 1120 and shared internal memory 1115. Memory controller 1120 and shared internal memory 1115 may be coupled to processing engines 1105 via a single bus or multiple buses to minimize memory access delays.

Processing engines 1105 may operate in parallel to achieve high data throughput. Typically, to ensure maximum processing power, each processing engine 1105 processes multiple threads and can implement instantaneous context switching between threads. In one embodiment, parser 315, classifier 320, and flow manager 330 are executed by one or more of processing engines 1105. In one embodiment, processing engines 1105 are pipelined and operate to classify incoming packets 115 into multiple flows concurrently. In an embodiment where parser 315, classifier 320, and flow manager 330 are software entities, these software blocks may be stored remotely and uploaded to processing device 1100 via control plane software or stored locally within external memory 1125 and loaded therefrom. In the latter embodiment, external memory 1125 may represent any non-volatile memory device including a hard disk or firmware. It should be appreciated that various other elements of processing device 1100 have been excluded from FIG. 11 and this discussion for the purposes of clarity.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method of packet classification, comprising:
receiving a packet including a packet field having a corresponding field value; and
indexing into a direct lookup table (“DLT”) at a DLT offset matching the field value to determine whether one or more of classification rules for classifying the packet into one or more flows are indexed at the DLT offset matching the field value, wherein the DLT includes at least a portion of the classification rules indexed at any of multiple DLT offsets within the DLT according to two or more bit matching masks.

2. The method of claim 1, further comprising:
indexing into multiple DLTs each corresponding to one of a plurality of packet fields of the packet to determine matching classification rules for each of the packet fields;
intersecting the matching classification rules corresponding to each of the packet fields to determine whether one or more resultant matching classification rules are common to all of the packet fields; and
classifying the packet into the one or more flows, if the intersecting determines that one or more resultant matching classification rules exists.

3. The method of claim 1, wherein the at least one bit matching mask includes an exact match mask wherein one of the classification rules is indexed to the DLT offset having an exact match with the field value.

4. The method of claim 3, wherein the two or more bit matching masks include a range match mask wherein one of the classification rules is indexed to a range of DLT offsets within the first DLT matching a corresponding range of field values of the packet field.

5. The method of claim 3, wherein the two or more bit matching masks include a wildcard match mask wherein one of the classification rules is indexed at all DLT offsets within the DLT, each of the DLT offsets matching one of all possible field values of the packet field.

6. The method of claim 3, wherein the two or more bit matching masks include a prefix match mask wherein one of the classification rules is indexed at each DLT offset of the DLT having a specified number of most significant bits matching a corresponding number of most significant bits of the field value.

7. The method of claim 3, wherein the two or more bit matching masks include a non-contiguous bit match mask wherein one of the classification rules is indexed at each DLT offset of the DLT having bit values at specified non-contiguous bit positions matching corresponding bit values at corresponding non-contiguous bit positions of the field value.

8. The method of claim 1, wherein the DLT comprises a strided DLT of multiple strided DLTs, and further comprising:
segmenting the packet field into packet sub-fields having corresponding sub-field values;
indexing into the multiple strided DLTs based on the corresponding sub-field values to determine matching classification rules for the sub-field values; and
intersecting the matching classification rules for the sub-field values to determine whether one or more resultant matching classification rules exists for the packet field.

9. The method of claim 8, wherein the packet field comprises an Internet Protocol (“IP”) address header field of the packet and wherein the packet sub-fields each comprise a portion of the IP address header field.

10. A machine-accessible medium that provides instructions that, if executed by a machine, will cause the machine to perform operations comprising:
receiving a packet including a packet field having a field value;
segmenting the packet field into packet sub-fields having corresponding sub-field values;
indexing into multiple strided direct lookup tables (“DLTs”) at DLT offsets matching the corresponding sub-field values to determine matching classification rules for each of the sub-field values, wherein each of the strided DLTs corresponds to one of the packet sub-fields of the packet field, wherein each of the strided DLTs includes at least a portion of classification rules indexed to the DLT offsets; and
intersecting the matching classification rules for each of the sub-field values to determine whether one or more resultant matching classification rules exists for the packet field to classify the packet into a flow.

11. The machine-accessible medium of claim 10, further providing instructions that, if executed by the machine, will cause the machine to perform further operations, comprising:
selecting a new classification rule including a new field value having a bit matching mask applied to the new field value, the new classification rule corresponding to the packet field;
segmenting the new field value having the bit matching mask applied thereto into new sub-field values corresponding to each of the strided DLTs; and
adding the new classification rule at each DLT offset within each of the strided DLTs matching the corresponding one of the new sub-field values.

12. The machine-accessible medium of claim 11, wherein the bit matching mask comprises one of an exact match mask, a range match mask, a wildcard match mask, a prefix match mask, or a non-contiguous bit match mask.

13. The machine-accessible medium of claim 10, further providing instructions that, if executed by the machine, will cause the machine to perform further operations, comprising:
varying stride sizes of a portion of the strided DLTs.

14. The machine-accessible medium of claim 13, further providing instructions that, if executed by the machine, will cause the machine to perform further operations, comprising:
selectably trading off memory consumption for classification time by increasing the stride sizes of the strided DLTs and decreasing a number of the strided DLTs.

15. The machine-accessible medium of claim 10, wherein classification time is independent of a total number of the classification rules.

16. The machine-accessible medium of claim 10, wherein memory consumption is independent of a total number of the classification rules.

17. The machine-accessible medium of claim 11, wherein a time consumed adding the new classification rule is independent of a total number of the classification rules indexed within each of the strided DLTs.

18. A network processing system, comprising:
a processing engine to execute instructions;
a network interface coupled to the processing engine; and
a hard disk coupled to the processing engine, the hard disk providing instructions that, if executed by the processing engine, will cause the processing engine to perform operations comprising:
receiving a packet including a packet field having a corresponding field value; and
indexing into a direct lookup table (“DLT”) at a DLT offset matching the field value to determine whether one or more of classification rules for classifying the packet into one or more flows are indexed at the DLT offset matching the field value, wherein the DLT includes at least a portion of the classification rules indexed at any of multiple DLT offsets within the DLT according to two or more bit matching masks.

19. The network processing system of claim 18, wherein the two or more bit matching masks include at least two bit matching masks selected from the following list:
an exact match mask wherein one of the classification rules is indexed to the DLT offset having an exact match with the field value;
a range match mask wherein one of the classification rules is indexed to a range of DLT offsets within the DLT matching a corresponding range of field values of the packet field;
a wildcard match mask wherein one of the classification rules is indexed at all DLT offsets within the DLT, each of the DLT offsets matching one of all possible field values of the packet field;
a prefix match mask wherein one of the classification rules is indexed at each DLT offset of the DLT having a specified number of most significant bits matching a corresponding number of most significant bits of the field value; and
a non-contiguous bit match mask wherein one of the classification rules is indexed at each DLT offset of the DLT having bit values at specified non-contiguous bit positions matching corresponding bit values at corresponding non-contiguous bit positions of the field value.

20. The network processing system of claim 18, wherein the DLT comprises a strided DLT of multiple strided DLTs, and further comprising:
segmenting the packet field into packet sub-fields having corresponding sub-field values;
indexing into each of the multiple strided DLTs based on the corresponding sub-field values to determine matching classification rules for each of the sub-field values; and
intersecting the matching classification rules for each of the sub-field values to determine whether one or more resultant matching classification rules exists for the packet field.

21. The network processing system of claim 20, further comprising selectably trading off memory consumption for classification time by increasing the stride sizes of the strided DLTs and decreasing a number of the strided DLTs.
